(19) United States
(12) Patent Application Publication
(10) Pub. No.: US 2023/0284636 A1
(43) Pub. Date: Sep. 14, 2023

(54) Process for preparing fresh leavened flaky pastry and fresh pastry product made according to said process

(71) Applicant: CERELIA, LIEVIN (FR)

(72) Inventors: Gérard FRITSCH, Mundolsheim (FR); Roshan RAOUF, Pont-Ste-Maxence (FR); Claire POIRETTE, Quesnoy sur Deule (FR)

(21) Appl. No.: 18/118,613

(22) Filed: Mar. 7, 2023

(30) Foreign Application Priority Data
Mar. 8, 2022 (FR) 22 01996

(51) Int. Cl. A21D 13/16; A21D 15/02

(52) U.S. Cl. CPC A21D 13/16; A21D 15/02

(57) ABSTRACT

A process for preparing fresh leavened flaky pastry includes the steps of; a mixing the basic products; b) preparing the batter; c) rolling; d) inclusion of fat; e) layer-rolling; f) cutting the pastry into quadrilaterals; g) shaping the pastry quadrilateral; h) bringing to the refrigeration temperature; and i) storage at the refrigeration temperature. Between steps g) and h), additional steps are included for j) cold solidification at a negative temperature above the crystallization temperature of the pastry; and k) oiling and/or vacuum packing of the pastry.

### RELATED APPLICATION

This application claims the benefit of priority from French Patent Application No. 22 01996, filed on Mar. 8, 2022, the entirety of which is incorporated by reference.

### FIELD OF THE INVENTION

The present invention relates to a process for preparing fresh leavened flaky pastry and a fresh pastry product made according to said process.

### BACKGROUND

The expression “fresh leavened flaky pastry” means that the leavened flaky pastry does not undergo a freezing step for its long-term storage.

The term “pastry product” covers products which undergo a volume increase, for instance croissants and filled products such as pains au chocolat or cinnamon rolls.

The known process for preparing fresh leavened flaky pastry comprises the usual steps of: mixing the basic products, preparing the batter, rolling, including fat, layer-rolling, cutting the pastry into rectangles, placing the pastry rectangle rolled up in a cardboard-aluminium-plastic composite box and storing it at a refrigeration temperature below 8° C.

At the time of consumption, the pastry rectangle is unrolled and cut into individual portions, each individual portion being shaped and baked. In the case where the pastry product is a croissant, the individual portions are triangular and are rolled up before baking. After baking, they generally have a brioche-like texture rather than a flaky texture.

### OBJECTS AND SUMMARY

One of the aims of the invention is to propose a fresh leavened flaky pastry with organoleptic qualities superior to those of canned pastry-product pastry.

Another aim of the invention is to propose packaging for fresh leavened flaky pastry which ensures optimum long-term storage.

The subject of the invention is a process for preparing fresh leavened flaky pastry, including the steps of:
a) mixing the basic products;
b) preparing the batter;
c) rolling;
d) inclusion of fat;
e) layer-rolling;
f) cutting the pastry into quadrilaterals;
g) shaping the quadrilateral;
h) bringing to the refrigeration temperature;
i) storage at the refrigeration temperature, characterized in that, between steps g) and h), it includes the steps of:
j) cold solidification at a negative temperature above the crystallization temperature of the pastry,
k) oiling and/or vacuum packing of the pastry.

In one embodiment, the process includes the two steps of
l) cutting the pastry quadrilateral into individual portions,
m) shaping the individual portion into a pastry product.

According to one embodiment, steps l) and m) take place between step g) of shaping the quadrilateral and step j) of cold solidification.

According to one embodiment, steps l) and m) take place after step i) of storage at the refrigeration temperature.

A subject of the invention is also a fresh pastry product made according to the process described above.

### DETAILED DESCRIPTION

The invention is described hereinbelow in relation to a recipe for leavened flaky pastry, comprising, as weight percentages of the pastry:

| | |
|---|---|
| flour | 30-35 |
| gluten | <5 |
| sugar | 2-10 |
| salt | <2 |
| stabilizer | <1 |
| fat in the batter | 5-10 |
| raising powders | <3 |
| water | 15-20 |
| preserving agent | <3 |
| fat in the layer-rolled pastry | 20-30 |

The stabilizer contributes towards better integrity of the pastry during the steps of the preparation process such as cooling above the crystallization temperature of the pastry, placing under vacuum, and returning to the refrigeration temperature, between 0° C. and +8° C. It ensures the stabilization of the pastry during its raw life, and the conservation of the pastry's shape and flakiness. It ensures better retention of carbon dioxide in the pastry, and better development of the pastry product during baking. The stabilizer is preferably a xanthan gum or guar gum or other another hydrocolloid.

The raising powders advantageously contain potassium or sodium bicarbonate, and glucono-delta-lactone and diphosphates.

The preserving agent ensures that a stable and healthy pastry is obtained from a food safety/microbiological viewpoint during its shelf life, between 0 and 8° C. Advantageously, it consists of an alcohol and/or organic acids or salts thereof, biological agents, or an ingredient containing molecules with a preserving effect such as fermented flour.

The fat is used both in the preparation of the batter and in the layer-rolling. The proportions described ensure easy mechanical processing of the pastry and a high flaky quality. The fat is advantageously a vegetable fat alone, or a mixture of several fats, or butter alone.

The recipe described above can advantageously be supplemented with a flavouring related to the pastry products sector; with a breadmaking or milling improver (in a proportion of <1%), such as ascorbic acid, enzyme(s), emulsifier(s), providing better stability of the pastry during the preparation process; with a milk powder (0-4%) which adds flavour and additional colouring to the baked pastry product.

The process for preparing fresh leavened flaky pastry corresponding, for example, to the abovementioned recipe, comprises a succession of conventional steps and non-obvious novel steps.

The conventional steps are:
a) mixing the basic products,
b) preparing the batter which forms the pastry base,
c) rolling,
d) inclusion of fat,
e) layer-rolling, which consists in folding, rolling out and turning the pastry several times to form superimposed folds enclosing the fat between the layers of batter,
f) cutting the pastry into quadrilaterals, for example rectangles,
g) shaping the quadrilaterals for packaging,
h) bringing to the refrigeration temperature; and
i) storage at the refrigeration temperature.

The novel steps are:
j) cold solidification at a negative temperature above the crystallization temperature of the pastry;
k) oiling and/or vacuum-packing of the pastry;
l) cutting the pastry quadrilateral into individual portions;
m) shaping the individual portion into a pastry product.

The term “shaping the pastry product” corresponds, for example, to rolling for croissants or filling for pains au chocolat or cinnamon rolls.

According to one embodiment of the invention, after steps a) to g), the novel steps are inserted in the following order:
l) cutting the pastry quadrilateral into individual portions;
m) shaping the individual portion into a pastry product;
j) cold solidification at a negative temperature above the crystallization temperature of the pastry;
k) oiling and/or vacuum packaging of the cold-solidified pastry.

Thus, the individual portion of pastry, shaped as a pastry product, is stored under vacuum, at the refrigeration temperature, in a barrier packaging, for example a plastic film, and then in a suitable handling and transportation packaging, for instance a cardboard box.

Cold solidification, at a negative temperature above the crystallization temperature of the pastry, ensures the stability of the shape of the fresh pastry product for vacuum packing.

Vacuum packing ensures that the characteristic rheological quality of the raw flaky pastry is retained, without the need for freezing.

According to another embodiment, after steps a) to g), the following novel steps are inserted:
j) cold solidification at a negative temperature above the crystallization temperature of the pastry,
k) oiling and/or vacuum packaging of the cold-solidified pastry.

Then, after the conventional steps h) and i), the following novel steps take place:
l) cutting the pastry rectangle into individual portions; and
m) shaping the individual portion into a pastry product before baking.

The process for preparing fresh leavened flaky pastry according to the invention affords the pastry products:
a quality of vacuum packaging ensuring a long shelf life, greater than 30 days, with organoleptic characteristics of superior quality, close to those of hand-crafted pastry products, and
in one of the embodiments, a format of individual pastry products already pre-rolled for croissants, or pre-filled for pains au chocolat or cinnamon rolls, for example.

1. A process for preparing fresh leavened flaky pastry, including the steps of:
a) mixing the basic products,
b) preparing the batter,
c) rolling,
d) inclusion of fat,
e) layer-rolling,
f) cutting the pastry into quadrilaterals,
g) shaping the pastry quadrilateral,
h) bringing to the refrigeration temperature,
i) storage at the refrigeration temperature, wherein, between steps g) and h), it includes the steps of:
j) cold solidification at a negative temperature above the crystallization
temperature of the pastry,
k) oiling and/or vacuum packing of the pastry.

2. The preparation process according to claim 1, wherein the process includes the two steps of:
l) cutting the pastry quadrilateral into individual portions, and
m) shaping the individual portion into a pastry product.

3. The preparation process according to claim 2, wherein steps l) and m) take place between step g) of shaping of the pastry quadrilateral and step j) of cold solidification.

4. The preparation process according to claim 2, wherein steps l) and m) take place after step i) of storage at the refrigeration temperature.
